(19) United States
(12) Patent Application Publication
(10) Pub. No.: US 2013/0318033 A1
(43) Pub. Date: Nov. 28, 2013

(54) Method for Operating an Automation Device

(71) Applicant: Rudolf POHLAN, Waldbronn (DE)

(72) Inventor: Rudolf POHLAN, Waldbronn (DE)

(21) Appl. No.: 13/901,273

(22) Filed: May 23, 2013

(30) Foreign Application Priority Data
May 24, 2012 (EP) 12169328

(51) Int. Cl. G06F 17/30

(52) U.S. Cl. CPC G06F 17/30563
USPC 707/602

(57) ABSTRACT

A method for operating an automation device, into the memory of which an automation solution has been loaded, wherein a technology-oriented control interpreter accesses a data warehouse of the automation solution, and is able to control external commands by virtue of such commands being analyzed and being implemented according to the analysis, where the technology-oriented control interpreter extracts at least one entity designation and at least one instruction from a respective command, the technology-oriented control interpreter searches for an object matching the entity designation in the data warehouse of the automation solution and, in the event of success, checks whether the instruction contained in the command has been defined for the found object, and where the technology-oriented control interpreter causes execution of the instruction for the found object.

### BACKGROUND OF THE INVENTION

1. Field of the Invention

The invention relates to a method for operating an automation device and to a method for accessing an automation device and, more particularly, to a method for accessing an automation solution loaded or running on an automation device.

Both method aspects are combined here and below under the title of a method for operating an automation device. Here, the term automation device also comprises process computers and special programmable logic controllers (PLC). In this case, the automation solution is understood as meaning any program or any collection of programs loaded into an automation device or a plurality of automation devices to perform an automation task, including the data used or produced when executing the program or programs. In this case, the automation task relates to a technical process and the actuators, sensors, units and so on included in the process. The technical process controlled and/or monitored during the automation task is referred to as an installation for short below. An automation solution can be distributed among a plurality of automation devices. Consequently, the term automation device is intended to include, on the one hand, an individual automation device, but also a collection of communicatively connected automation devices, without express reference being made to a possible plurality of automation devices in each case.

2. Description of the Related Art

Conventional automation solutions are loaded onto automation devices in the form of programs or module lists. The respective installation is typically controlled by components of a control system, i.e., for example, one or more control and monitoring devices that are included in the system, by virtue of program variables or module variables being appropriately set in program or data modules. For the purpose of monitoring and diagnosis, actual values of such variables are cyclically or sporadically read and are displayed to an operator in a suitable manner.

Such control of an automation device is nowadays stipulated by the programming model of the respective automation device. In this case, the programming model is understood as meaning the organization of the program(s) and the data of an automation device type. The control of an automation device is stipulated by the respective programming model. As a result, the statement that a control model for accessing the automation device and the automation solution are also determined by the programming model in the previous prior art is justified.

However, this is not yet optimal because access according to the programming model scarcely allows interventions in the respective installation at a technological level. However, interventions in the installation at a technological level are particularly easy to understand because, for example, a unit to be influenced can be directly named with a comprehensible designation without the intervention having to be expressed—according to the programming model—by using conventionally rather cryptic designations of the variables used by the automation solution.

Convenient control and monitoring systems and devices, as well as diagnostic tools, are nowadays offered by all control system manufacturers and make it possible to display control and process images and the like during use. Such displays are designed for and can be understood by a technologist and an installation operator. However, the disadvantage is that changes in one or more programs on the automation device often also entail changes in the control and monitoring devices. This is especially the case when a structure or the names of program variables or data modules on the automation device change(s).

Virtually the character of a technology-oriented control interface on the automation device is achieved by technology-based program modules and variables, the technological connection of which is expressed, for use in the process industry, for example, by a corresponding name and/or commentary. Such program modules are often provided in program or module libraries. However, at best, they can be considered to be semi-technological because they necessarily comply with the programming model of the automation device. In particular, the disadvantage that changes to a program on an automation device also entail a need for changes in the control and monitoring devices continues to exist. In addition, the availability of the installation is restricted during such changes because interventions in the installation on control and monitoring devices are not possible in a period of time between the transmission of changed programs to the automation device and adaptation of the control and monitoring devices to these changes. In particular, the consistency between the structures of the control and monitoring variables and the corresponding program variables on the automation device may therefore be at risk, at least temporarily, particularly in phases of program changes, i.e., during installation optimization, for example. The availability of the control and monitoring system cannot be completely and continuously ensured in such phases. Therefore, the control and monitoring system is not ready for operation or is only partially ready for operation in such phases.

### SUMMARY OF THE INVENTION

It is therefore an object of the invention to provide an improved possibility for operating an automation device, in particular a possibility for operating an automation device having a technology-oriented control interface.

This and other objects and advantages are achieved in accordance with the invention by a method for operating an automation device, into the memory of which an automation solution has been loaded, a technology-oriented control interpreter and also the following are provided: the technology-oriented control interpreter, on the one hand, has access to a data or variable warehouse of the automation solution and, on the other hand, is able to control external commands, such as from a control and monitoring device, by virtue of such commands being analyzed and being implemented according to the analysis. During the analysis of a command, the technology-oriented control interpreter extracts at least one entity designation and at least one instruction from the respective command. The technology-oriented control interpreter uses the extracted entity designation to search for an object corresponding to the entity designation in the data warehouse of the automation solution. There can only be one exactly corresponding object for an entity designation in each case. This is referred to as the object matching the entity designation in the text below. In the event of success, i.e., when a matching object has been found during the search in the data warehouse of the automation solution, the technology-oriented control interpreter checks whether the instruction contained in the command has been defined for the found object. If this is the case, the technology-oriented control interpreter causes execution of the instruction for the found object.

The advantage of the invention is that it is possible to intervene in the installation, i.e., to perform control actions with respect to the installation, in a safe manner and at the technological level, i.e., independently of the programming model of the automation device, by virtue of corresponding commands being transmitted to the control interpreter. The control interpreter implements a technological control interface oriented to the technical orientation of the installation by analyzing and processing such commands. This interface is provided on one or more automation devices and, when used, allows permitted control actions with respect to the installation.

Because only those commands whose entity designation and instruction have been created in the data warehouse of the automation solution can be executed by the instruction interpreter, virtually a separate language with a language scope defined at the technological level thus results. The influencing possibilities of the control and monitoring device are thus restricted to what is allowed in this separate language. This is another crucial advantage of the invention.

In one embodiment of the method, the data warehouse of the automation solution is organized in a tree-like manner in a project tree that technologically describes the installation and has a plurality of objects, and an entity name path or part of such an entity name path is stated as the entity designation within the scope of the command addressed to the technology-oriented control interpreter. The tree-like structure of the project tree makes it possible to quickly traverse (search) the project tree. If the entity designation is stated in the form of an entity name path or a part of the entity name path, this statement already comprises information for directly or virtually directly locating the object referenced in this manner in the project tree.

The project tree and the objects and actions organized there continue the principle of the technologically defined language scope. Only objects of the project tree can be found using the respective entity designation or the entity name path. The possibility for influencing the installation is thus restricted to those units and components that are represented by a corresponding representative in the project tree, i.e., by an object of the project tree. The influencing possibility is also restricted to those units and components of the installation that are represented by a corresponding object in the project tree, to be precise by the actions defined for the respective object. If a rotational speed of a motor included in the installation can thus be readily changed in principle, for example, using the programming model of the automation device, by changing a memory content provided as the desired rotational speed value, such changes of a rotational speed using the technology-oriented control interpreter are possible only when, on the one hand, the motor is represented by a corresponding object in the project tree and, on the other hand, an action concerning the rotational speed of the motor has been defined for this object. It is not possible to influence the motor rotational speed if either the motor has not been represented in the project tree or no such action has been defined for the corresponding object in the case of a motor represented in the project tree. The functionality of the installation and of the units and components included in the latter is thus encapsulated in the automation device and the project tree defines a control interface and the permitted possibilities for intervening in the respective installation. The technology-oriented control interpreter allows the automatic use of the control interface and allows the indirect or direct execution of external commands, i.e., commands from a control and monitoring device for influencing the respective installation, for example.

In another embodiment of the method, individual objects of the project tree respectively define or reference at least one action as a basis for instructions that can be transmitted with an external command. This can best be explained using an example: if an installation comprises a plurality of valves and motors as actuators, each such actuator can be referenced using a unique entity designation, possibly an entity name path comprising the entity designation, such as “hot water valve”, “cold water valve”, “mixer motor” or “meter installation part.hot water valve”, “meter installation part. cold water valve” or “mix installation part.mixer motor”. A complete command can therefore read as follows, for example: “meter installation part.hot water valve.open”. The technology-oriented control interpreter analyses such a command and extracts, on the one hand, the entity designation or the entity name path, i.e., “hot water valve” or “meter installation part. hot water valve”, and the instruction, i.e., “open”, from the command. If a matching object is contained in the project tree and the actions “open” and “close” have been defined for the object, for example, the action “open” matching the instruction “open” transmitted in the command can be performed. At least two alternatives come into consideration with regard to performing such an action: either the object comprises, within the scope of the definition of the respective action itself, one or more program code instructions that are used to implement the respective action, or the object comprises a reference to an external memory location at which one or more program code instructions for implementing the respective action are stored. The program code instructions may be program code instructions in a machine language and therefore a form that can be directly executed by the processor of the respective automation device or may be program code instructions that are processed by an interpreter for execution, wherein, in the latter case, the technology-oriented control interpreter comprises such an interpreter functionality or has access to the latter in a suitable form.

In one embodiment of the method in which individual objects of the project tree respectively define or reference at least one action as the basis for instructions that can be transmitted with an external command, an action associated with an object of the project tree comprises one or more security queries. It can then be ensured, for example, that an “open” instruction for a valve is executed only when the other installation states allow this. For example, the executability of an “open” instruction may be made dependent on whether a collecting mold is situated at a position intended for it downstream of the valve or whether a reactor downstream of the valve is at least not filled to its maximum capacity or the like. One possible formulation of such a security query could read as follows in this case:

IF ( DM5.is < DM5.max ) THEN

DM6.open = 1

In this case, the designators “DM5” and “DM6” are valid designators within the scope of the programming model of the automation device and denote a respective data module (DM=data module). The designators “is”, “max” and “open” are variables defined in the data warehouse of the automation device and denote, for example, memory locations at which the current filling level of the mixer and an upper limit value for the filling level are stored, as well as an output that results in the hot water valve being opened.

In the same manner, it is also possible to perform mutual locking operations which, for example, in an installation in which a mixer container is charged from a plurality of reactors, ensure that the material is removed only from one reactor in each case because otherwise, although it is possible to determine an increase in the filling level in the mixer, this increase in the filling level cannot be unambiguously associated with precisely one inflowing material and it is thus not possible to comply with recipe specifications or the like. One possible formulation of a security query in this regard for a valve for removing material from a reactor would therefore comprise, for example, the query regarding whether all other valves for removing material from other reactors are closed. It should be understood that other types of locking operations are likewise conceivable.

In addition, security queries are also conceivable that are not directly correlated with installation states, for example, security queries which allow a particular command and allow the associated action to be performed only during manual operation, set-up operation or automatic operation.

Furthermore, authorization of the operator of the respective control and monitoring device may be checked as a security query. For this purpose, it is necessary for an operator to log onto the control and monitoring device to perform control actions and for the operator to then be allocated an authorization status. With regard to the security query, the action must then code a comparison regarding whether a respective security status meets the requirements. A command transmitted to the control and monitoring device can then be executed by executing an associated instruction only when the security status of the operator is sufficient.

The concept of the technologically defined language scope is thus continued further by virtue of executability of commands being tied or being able to be tied to conditions within this restricted language scope.

The advantage of the invention and its refinements can be divided into three different aspects:

1. It is easier to create control and monitoring programs because it is possible to operate with largely natural language expressions of a technologist without having to know the internal workings of storing the individual data items by the automation device.

2. Encapsulation. The control and monitoring device may cause the automation device to perform only what has also been created by the automation device in the technological project tree. It is no longer possible to directly access individual data items relating to the automation device, with the result that virtually a technologically defined language scope for control and monitoring actions that are “non-critical to security” is available for the control and monitoring device; special, i.e., for example, security-critical, control actions may be made dependent on an authorization level or another security query.

3. It is permanently possible to control the installation and the technical process implemented with the technical process because, in contrast to before, it is no longer necessary to keep the complete description of the program variables or module variables in a redundant manner both on the or each automation device and the or each control and monitoring device, since the control and monitoring device uses its language scope and, when corresponding “vocabulary” is used, the latter is evaluated by the control interpreter and its evaluation possibly results in the execution of program codes by the automation system, with the result that consistency of the data is required only on this side.

The control interpreter may be loaded, with the means of the operating system of the respective automation device, into the memory of the automation device, for example, into the memory of a programmable logic controller acting as the automation device, and can be executed there on a particular runtime system level cyclically or in an event-controlled manner. The approach presented here is useful, in particular, for manufacturers of programmable logic controllers because the ability to use such a programmable logic controller in a process control system as well can thus be considerably improved and it is possible to dispense with the development costs of a dedicated automation device for the process industry.

The abovementioned object is also achieved with an automation device for controlling and/or monitoring an installation for implementing a technical process, which operates according to the method described here and below and, for this purpose, comprises means for performing the method. As means for performing the method, the automation device comprises at least one processing unit in the form or manner of a microprocessor and a memory into which a computer program for implementing the method described here and below has been or can be loaded. In this respect, the invention is implemented using software. The invention is thus, on the one hand, also a computer program having program code instructions which can be executed by a computer and, on the other hand, a storage medium having such a computer program, i.e., a computer program product having program code means, as well as finally also an automation device, into the memory of which such a computer program has been or can be loaded as means for performing the method and its refinements.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in more detail below using the drawing. Items or elements which correspond to one another are provided with the same reference symbols in all figures, in which:

FIG. 1 shows an automation device for controlling an installation for implementing a technical process, in which case it is possible to access the automation device and thus the installation using a control and monitoring device;

FIG. 2 shows individual details when the control and monitoring device interacts with a technology-oriented control interpreter implemented on the automation device;

FIG. 3 shows an overview of a possibility of accessing a data warehouse of the automation device using the technology-oriented control interpreter;

FIG. 4 shows variants for accessing the data warehouse of the automation device in this manner; and

FIG. 5 is a flowchart of the method in accordance with the invention.

### DETAILED DESCRIPTION OF THE PREFERRED EMBODIMENTS

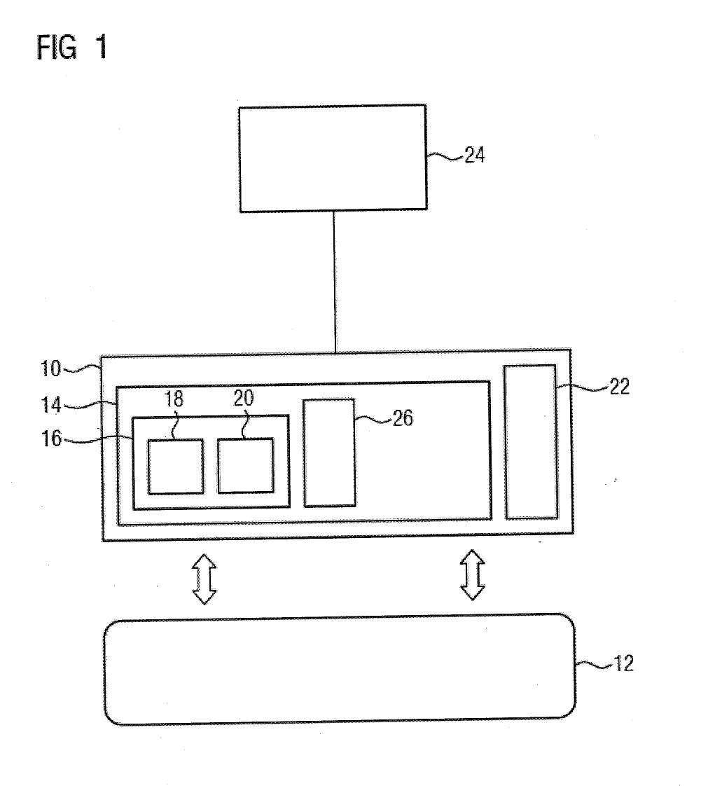

FIG. 1 diagrammatically shows, in a highly simplified manner, an automation device 10 which, for the purpose of simplifying the illustration and the further description, is representative here of a fundamentally arbitrary number of automation devices which are communicatively connected to one another. The automation device 10 is intended and configured to control and/or monitor an installation 12 (not illustrated in any more detail). The installation 12 performs a respective technical process, for example, a process for converting or transporting material, energy or information etc., and the installation comprises, for this purpose, conventional units and components as well as sensors and actuators for receiving state information from the process and for intervening in the installation, i.e., for influencing the process.

In order to control and/or monitor the installation 12, the automation device 10 has, in a memory 14, an automation solution 16 in the form of one or more programs 18, i.e., one or more computer programs with program code instructions, as well as the data 20 produced or used by the or each program 18. In order to simplify the further description, this is continued using the example of precisely one program 18 included in the automation solution 16, without dispensing with further generality. The program 18 is executed by a processing unit 22, i.e., for example, a microprocessor or the like, during operation of the automation device 10.

The automation solution 16, and especially the functionality of the program 18 included in the solution, determines, in a manner known per se, the automatic or semiautomatic flow of the technical process and the interaction between the automation device 10 and the installation 12 that is required for this purpose. In addition, it is also possible to intervene in the installation 12 via one or more control and monitoring devices 24, in which case, in order to simplify the description but without dispensing with further generality, the description is continued in this case too using the example of precisely one control and monitoring device 24. For such interaction, the control and monitoring device 24 and the automation device 10 are communicatively connected in a wireless or wired manner in a manner known per se.

Intervention in the installation 12 using a control and monitoring device 24 is not effected directly by the control and monitoring device 24 but rather indirectly via the automation device 10 and its automation solution 16. According to the prior art, it is necessary for a complete data warehouse of the automation device 10 to also be known to the control and monitoring device 24 for this purpose to thus be able to use individual variables created in the program 18 and thus data 20 of the automation solution 16. Such intervention is therefore referred to as intervention in the installation 12 based on the programming model of the automation device 10. In order to close a valve, a suitable value (e.g., DM6.open=1) is entered in this case in a variable that influences the state of the valve during a transfer of a process image of the outputs.

The invention breaks with the previously consistently pursued concept of using the programming model of the automation device 10 to control an installation being controlled and/or monitored in each case.

For this purpose, the automation device 10 has, in its memory 14, a further computer program which is referred to as the control interpreter 26 below for distinguishing purposes.

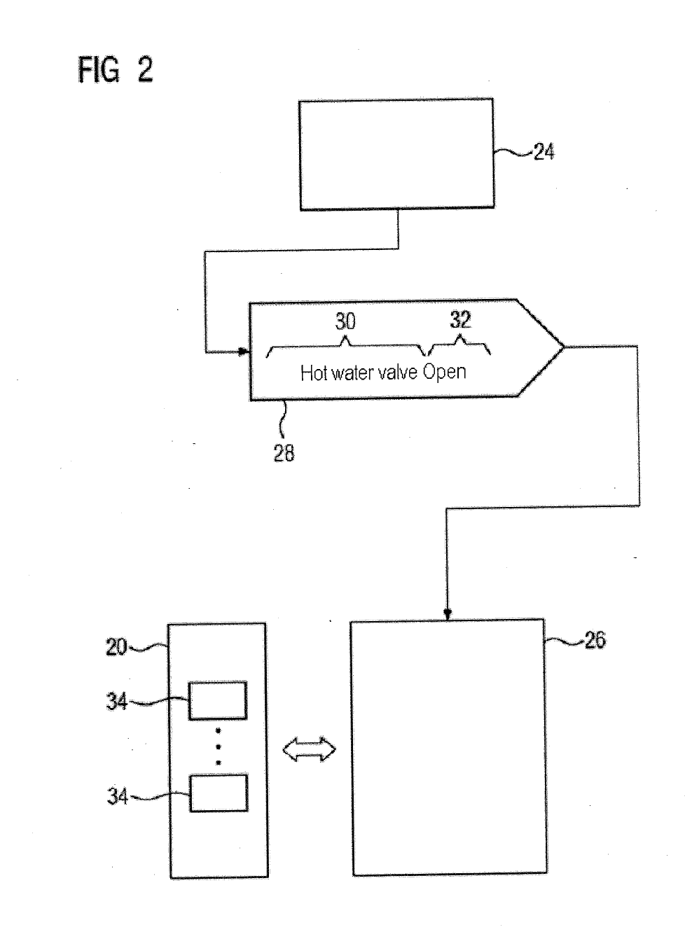

In this respect, FIG. 2 shows, on the one hand, an excerpt from the illustration in FIG. 1 and, on the other hand, further details in connection with the control interpreter 26. The control interpreter 26 is a technology-oriented control interpreter 26, with the result that the technology-oriented control interpreter 26 must not be confused with other interpreters or control interpreters in this respect. In the sense of a linguistically concise description, the technology-oriented control interpreter 26 is sometimes also referred to only as the control interpreter 26 for short.

The control interpreter 26, on the one hand, has access to the data warehouse of the automation solution 16 and thus to its data 20. On the other hand, the control interpreter 26 can control external commands 28, i.e., for example, commands 28 coming from the control and monitoring device 24, by virtue of such commands 28 being analyzed and being implemented according to the analysis. The transmission of a command 28 to the control interpreter 26 is illustrated in FIG. 2 using corresponding arrows that start from the control and monitoring device 24 and end at the control interpreter 26. The command 28 comprises an entity designation 30, namely here as an example “hot water valve”, and an instruction 32, namely here as an example “open”. The control interpreter 26 extracts at least one entity designation 30 and at least one instruction 32 from a respective command 28. For this purpose, the control interpreter 26 has a conventional parser functionality and allows analysis of a command 28 transmitted in the form of a character string, which is required for this purpose, and the subsequent extraction of individual elements of the character string. The control interpreter 26 then searches the data warehouse of the automation solution 16, i.e., the data 20, for an object 34 matching the extracted entity designation 30. In the event of success, i.e., if a matching object 34 has been found, the control interpreter 26 checks whether the instruction 32 contained in the command 28 has been defined for the found object 34. If this is also the case, the technology-oriented control interpreter 26 causes execution of the instruction 32 for the found object 34.

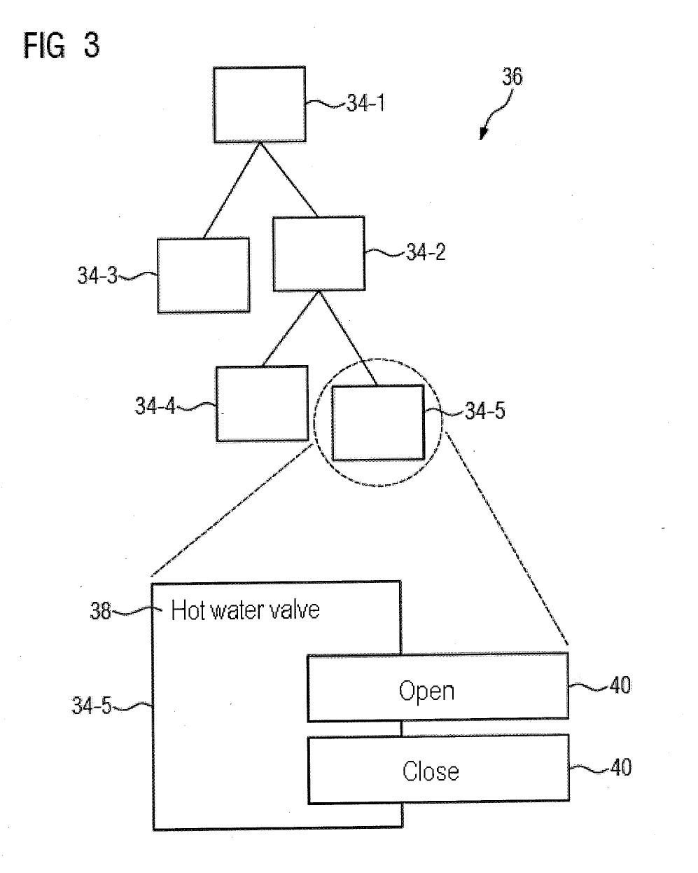

This is explained further using FIG. 3 in which the objects 34 are organized in a hierarchically tree-like manner, for example, in the form of a project tree 36. The use of a project tree 36 and the resultant tree-like structure are optional even if the tree-like organization of the data is a particularly clear structure that is easy to search.

In the illustration in FIG. 3, the project tree 36 comprises five objects 34 that are denoted by 34-1, 34-2, 34-3, 34-4 and 34-5 for the purpose of distinguishing them. A first object 34-1 is the root of the project tree 36 and thus represents the entire installation 12, for example. A second object 34-2 and a third object 34-3 arranged hierarchically below said object 34-1 represent, for example, an installation part, here an installation part for metering and an installation part for mixing, for example. Objects representing components of the respective installation parts are situated in a level arranged hierarchically below this. Only two further objects 34, i.e., a fourth object 34-4 and a fifth object 34-5 that are intended to represent a cold water valve and a hot water valve, are shown here. It is clear that such a project tree 36 in reality is much more comprehensive than is illustrated here and the illustration is restricted only for reasons of clarity and, for the rest, is not intended to show a complete project tree 36 but rather is intended to facilitate the understanding of individual aspects of the approach presented here.

The lower region of the illustration in FIG. 3 shows, as representative of the objects 34 included in the project tree 36, the fifth object with further details. Each object 34 has an entity name 38, and the entity name 38 of the fifth object 34-5 illustrated on an enlarged scale is “hot water valve” because it was assumed here that the fifth object represents a hot water valve. It goes without saying that the entity names 38 and further names and designations mentioned below are freely selectable in principle, but descriptive names that thus give an indication of the respective function are recommended in the sense of better comprehensibility of the function of the individual objects 34. One or more actions 40 may have been defined for each object 34 and the actions 40 “open” and “close” have been defined, for example, for the illustrated fifth object 34-5. In this case, the designations “open” and “close” are first of all only the names of the actions 40 and these names are used, on the one hand, to check whether a particular action 40 has actually been defined for a particular object 34 and, on the other hand, to possibly call an action 40.

If, according to FIG. 2, a command 28 with an entity designation 30 “hot water valve” and an instruction 32 “open” thus passes to the control interpreter 26, the control interpreter 26 divides the command 28 into the entity designation 30 and the instruction 32 during analysis of the incoming instruction 28. If the data warehouse of the automation solution 16 is organized in a tree-like manner in a project tree 36 having a plurality of objects 34, as shown in FIG. 3, the control interpreter 26 searches the project tree 36 for the object 34 (corresponding object 34) matching the entity designation 30, i.e., an object 34 whose entity name 38 matches the entity designation 30 stated in the command 28 or an entity name path stated in the command 28. In the event of success, i.e., if a matching object in this sense has been found, which is the case in the situation of the fifth object 34-5 shown in FIG. 3, the control interpreter 26 checks whether the instruction 32 contained in the command 28 has been defined for the located object 34.

An action 40 with a matching designation can actually be found for the instruction 32 “open” in the found object 34-5. Based on these investigations, the control interpreter 26 thus “knows” how the incoming command 28 must be processed, i.e., by performing the found action 40 “open” for the found object 34-5 “hot water valve”.

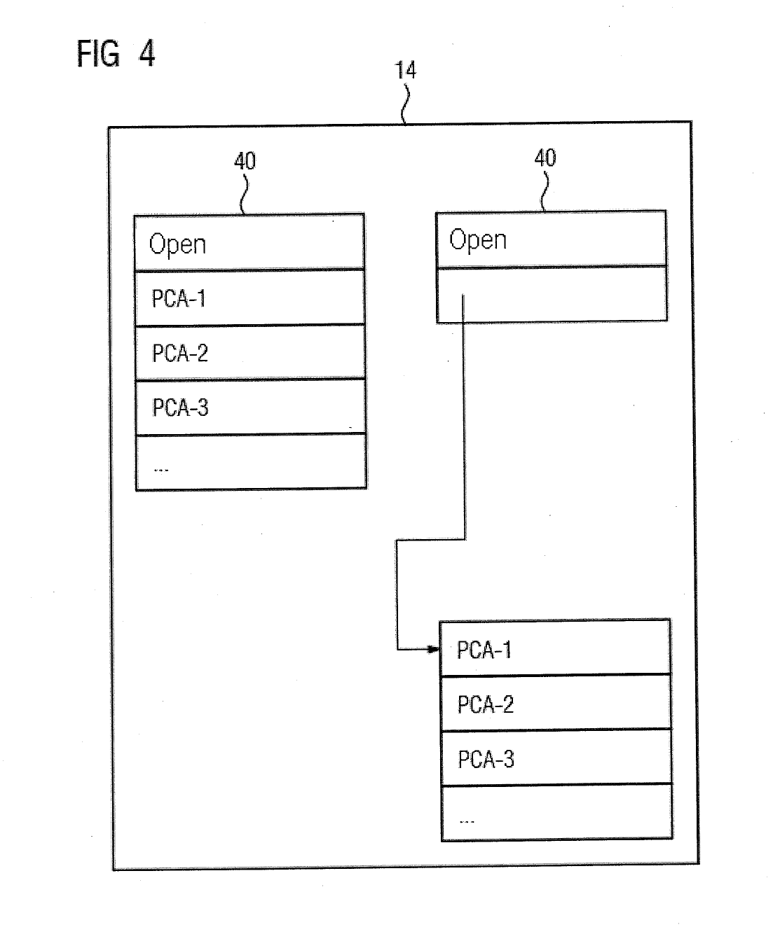

The aspect of executing a command 28 arriving at the control interpreter 26 and the resultant performance of an action 40 for an object 34 from the data warehouse of the automation solution 16 are explained further in FIG. 4. In this case, FIG. 4 shows two conceivable variants. The left-hand side of the illustration in FIG. 4 shows that the action 40 itself comprises a plurality of program code instructions illustrated only symbolically here as PCA-1, PCA-2, etc. in order to implement the functionality of the respective action 40. Alternatively, the action may also comprise a reference (illustrated on the right-hand side of the illustration in FIG. 4 via an arrow) to a sequence of program code instructions for implementing the functionality of the respective action 40, which sequence is stored at a different location in the memory 14 of the automation device 10. The use of a reference has the advantage that the storage requirement of the project tree 36 and of the objects 34 included in the latter remains as low as possible.

In the selected example, the program code instructions are effective for setting a memory location, which influences the state of the relevant valve during the transfer of the process image of the outputs and triggers opening of the valve, to a value required for this purpose (i.e., “DM6.open=1”). If an object 34 represents another unit or another actuator inside the installation 12, these statements apply accordingly.

In addition, the program code instructions may implement checks, locking operations, particularly with regard to synchronization purposes, security queries, authorization queries and so on before or after a memory location is influenced in a suitable manner. As a result, the possibility for influencing the installation 12, as coded by the respective action 40, is restricted to situations in which such checks and the like lead to a result needed to perform the action 40 further. One possibility of formulating such checks is known per se, with the result that further statements are unnecessary here, apart from the suggestion that this is possible in the simplest case using an “if-then instruction”. The nature and scope of such checks may have any desired complexity in principle and may include evaluation of a multiplicity of logical and/or arithmetic relationships.

One particularly favorable possibility for using references in an action 40 defined for an object 34 in the project tree 36 is in the form of a function call (FC) in which a numerical value referred to as an index here makes it possible to select a special subfunctionality of the function called.

Such a function, which can be distinguished from other functions, for example, by adding a numerical value, i.e., for example, a function with the designation “FC80”, can be implemented in this case as follows:

| case index | |
|---|---|
| 1: | PCA-1-1 |
| | PCA-1-2 |
| | .. |
| | break |
| 2: | PCA-1-1 |
| | PCA-1-2 |
| | .. |
| | break |
| .. | |
| 7: | if ( condition ) |

DM6.open = 1

break

endcase

In this manner, a multiplicity of functionalities which can be called with an action 40 can be combined in one function. The referencing of such a function and the respective subfunctionality therein may read as follows for example: “FC80, Index=7, Parameter, . . . ”.

Each command 28 may comprise one or more parameters and each parameter may act as an input parameter, an output parameter or an input/output parameter. The program code instructions for implementing a respective action 40 are thus also effective for disposing of and supplying individual parameters or a plurality of parameters in a parameter list for a respective command 28.

In this manner, virtually a separate language for intervening in the respective installation 12 can be defined in a project tree 36 within the data warehouse of the automation device 10 by creating objects 34 with at least one respective action 40, possibly by combining and hierarchically structuring such objects 34. The names of the objects 34 and the designations of the actions 40 defined for the objects 34 are the vocabulary of this language. The vocabulary is used by transmitting a command 28 to the control interpreter 26. The control interpreter 26 then checks as it were the syntax of this language by virtue of only those commands 28 whose entity designation 30 and instruction 32 find an equivalent in the form of a matching object 34 and a matching action 40 defined for this object 34 in the data warehouse of the automation device 10 actually being executed. Overall, a language is thus defined at the abstract level, which language is independent of the programming model of the automation device 10 and thus allows interventions in the installation 12 respectively being controlled and/or monitored independently of the programming model of the automation device 10. For further simplification of the following description, the previously presented concept is also only referred to as a language for short, in which case it goes without saying that the term language actually includes only the effects and advantages of the underlying technical solution.

As described, individual commands 28 of such a language are aimed at influencing a state of the installation, for instance by closing a valve. Commands 28 that detect a state of the installation, such as whether a valve is closed, whether a maximum filling level of a mixer container or the like has been reached and so on, are likewise conceivable and provided. All of the possible commands 28 can thus be roughly divided into two groups, i.e., on the one hand, technological instruction commands, which are intended to be used to influence a state of the installation 12 and, on the other hand, technological status commands which are used to query a state of the installation 12.

As described, the program variables according to the programming model of the automation device 10 are used to implement these commands 28 in the form of a respective action 40 associated with an object 34. However, these program variables do not become visible to the outside and are encapsulated by the objects 34 and their actions 40. The objects 34 and the actions 40 therefore define not only the abovementioned language but also a well-defined interface to such program variables and the like.

Some examples of technological instruction commands and technological status commands are stated below.

Standard instruction commands for technical functions:

Stop (state change)

Continue (state change)

Instruction commands for individual control units such as motors, valves, etc.:

Predefine motor rotational speed (with rotational speed parameter)

Start motor

Open valve

Close valve

Standard status commands for technical functions:

RUN (operating state sequence control)

STARTING (operating state sequence control)

Desired value reached

Status commands for individual control units such as motors, valves, etc.:

Motor running

Motor stopped

Valve open

Valve closed

Control difference smaller (with parameter x)

The setting of a control variable is naturally also conceivable as a standard instruction command. Similarly, there may be a standard status command for querying a control variable.

With the approach presented here, program and/or module structures can be changed on the automation device 10 without the control and diagnostic devices also being inevitably affected. The novel control model, which is supported by the control interpreter 26 on the automation device 10, is independent of the respective programming model of the automation device 10. With this approach, it is even possible to access a plurality of automation devices 10 which each use a different programming model from the same control and monitoring device 24. It is then possible to intervene in the respective installation 12 during such access to these automation devices 10.

The control and monitoring device(s) 24 may thus be restricted to a technological control model and is/are thus independent of the program(s) 18 of the automation solution 16. This decoupling allows reaction-free program or program structure changes. The implementation of a command 28 in the form of an action 40 associated with an object 34 can be changed or expanded independently of the technology-oriented description of the functionality available on the control and monitoring device 24 and this change or expansion can be downloaded to the automation device 10.

The approach described here allows and enables novel software control tools which indirectly work directly on the program variables of the data warehouse of the automation device 10 without the variables becoming visible to the outside. Such control tools then work directly with technological or technology-oriented instruction and/or status commands that relate to individual units or assemblies, in particular individual control units and other technical devices, of the respective installation 12.

A commercially available laptop, smartphone, handheld control device, etc., which is connected to the physical installation bus or directly to the automation device 10, can be used for simple control of the installation by a technologist who does not require any programming knowledge for this purpose and without technological description data being available or required on the device used in each case.

The introduction of the control interpreter 26 makes it possible to centrally synchronize all interventions in the installation (instructions and status queries). In addition, the use of the control interpreter 26 allows a central assignment mechanism for individual control units or technical devices or even entire installation parts. The approach presented here is also a solution to the problem of shared resources if, for example, different modes of operation of an installation, such as setting up, producing, cleaning, etc., use the same individual control units or technical devices.

Although the invention has been illustrated and described in detail by means of the exemplary embodiment, the invention is not restricted by the example(s) disclosed and other variations can be derived therefrom by a person skilled in the art without departing from the scope of protection of the invention.

Individual aspects of the description submitted here which are in the foreground can therefore be briefly summarized as follows:

The disclosed invention is thus directed, inter alia, to a method for operating an automation device 10, into the memory 14 of which an automation solution 16 has been loaded, a technology-oriented control interpreter 26, on the one hand, having access to a data warehouse of the automation solution 16 and, on the other hand, being able to control external commands 28 by virtue of such commands 28 being analyzed and being implemented according to the analysis, the technology-oriented control interpreter 26 extracting at least one entity designation 30 and at least one instruction 32 from a respective command 28, the technology-oriented control interpreter 26 searching for an object 34 matching the entity designation 30 in the data warehouse of the automation solution 16 and, in the event of success, checking whether the instruction 32 contained in the command 28 has been defined for the found object 34, and the technology-oriented control interpreter 26 causing execution of the instruction 32 for the found object 34. This implements a technology-oriented possibility for a control and monitoring device 24 to be able to access an automation device 10 and the data created there in the programming model of the automation device 10 without itself having to know or even use the programming model of the automation device. The basis is a technological installation description, for example in the form of a project tree 36. The technology-oriented control interpreter 26 forms the interface between the control and monitoring device 24 and the commands 28 transmitted from there and such a technological installation description.

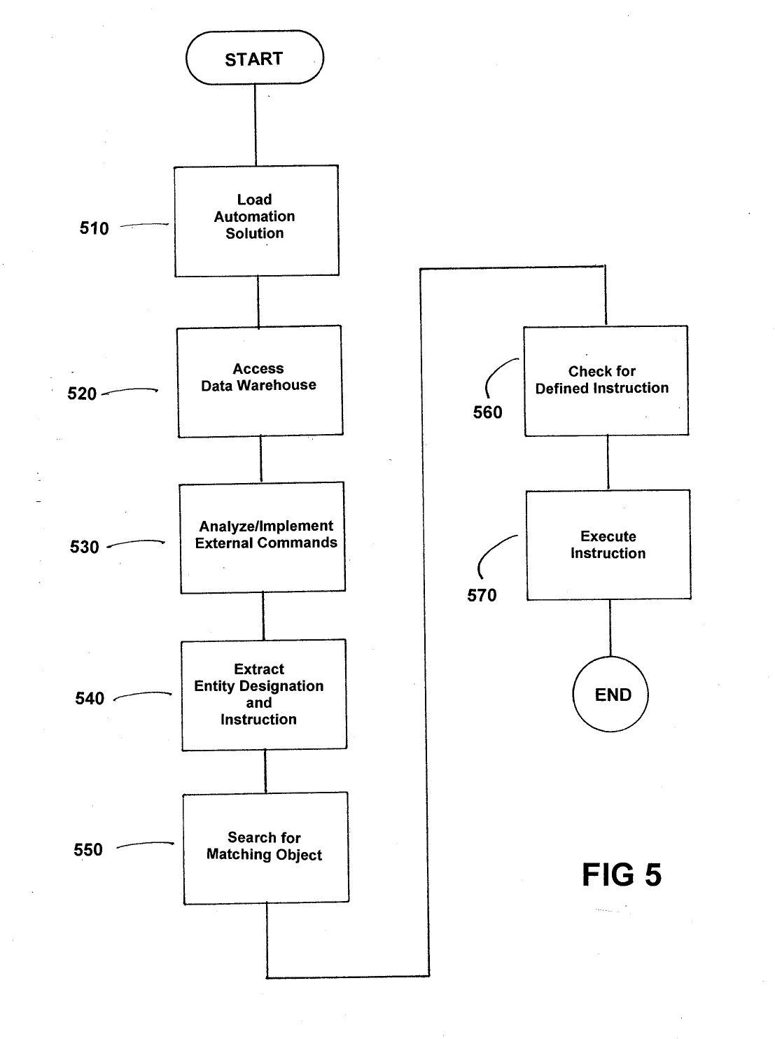

FIG. 5 is a flowchart of a method for operating an automation device having a memory. The method comprises loading an automation solution into the memory, as indicated in step5 510. A data warehouse of the automation solution is accessed by a technology-oriented control interpreter, as indicated in step 520.

Next, the technology-oriented control interpreter analyzes external commands and implements the external commands according to the analysis to control the external commands, as indicated in step 530. The technology-oriented control interpreter then extracts at least one entity designation and at least one instruction from a respective external command, as indicated in step 540.

The technology-oriented control interpreter then searches for an object matching the at least one entity designation in the data warehouse of the automation solution, as indicated in step 550. Next, a check is performed to determine whether the instruction contained in the command has been defined for the located object in an event of successfully locating the object matching the at least one entity designation in the data warehouse of the automation solution, as indicated in step 560. The instruction for the located object is now executed via the technology-oriented control interpreter, as indicated in step 570.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an automation device having a memory, comprising:
loading an automation solution into the memory;
accessing a data warehouse of the automation solution by a technology-oriented control interpreter;
analyzing, by the technology-oriented control interpreter, external commands and implementing said external commands according to said analysis to control the external commands;
extracting, by the technology-oriented control interpreter, at least one entity designation and at least one instruction from a respective external command;
searching, by the technology-oriented control interpreter, for an object matching the at least one entity designation in the data warehouse of the automation solution;
checking whether the instruction contained in the command has been defined for the located object in an event of successfully locating the object matching the at least one entity designation in the data warehouse of the automation solution; and
executing, via the technology-oriented control interpreter, the instruction for the located object.

2. The method as claimed in claim 1, wherein the data warehouse of the automation solution is organized in a tree-like manner in a project tree having a plurality of objects, and wherein an entity name path is stated as an entity designation within a scope of the external command addressed to the technology-oriented control interpreter.

3. The method as claimed in claim 2, wherein individual objects of the project tree respectively define or reference at least one action as a basis for instructions which are transmittable with the external command.

4. The method as claimed in claim 3, wherein an action associated with an object of the project tree comprises at least one security query.

5. The method as claimed in claim 3, wherein an action associated with an object of the project tree comprises at least one query for access protection.

6. The method as claimed in claim 4, wherein an action associated with an object of the project tree comprises at least one query for access protection.

7. The method as claimed in claim 3, wherein execution of a plurality of actions specified according to an instruction transmitted with a command is centrally synchronized.

8. The method as claimed in claim 4, wherein execution of a plurality of actions specified according to an instruction transmitted with a command is centrally synchronized.

9. The method as claimed in claim 5, wherein execution of a plurality of actions specified according to an instruction transmitted with a command is centrally synchronized.

10. A computer program having program code means for performing the steps of the method of claim 1 when the computer program is executed on an automation device for at least one of controlling and monitoring an installation.

11. A process in which an automation device having a memory, into which an automation solution is pre-loaded, executes instructions set forth in a computer program which serves as a technology-oriented control interpreter, said computer program executing in a processing unit which, when used on the automation device, causes the processing unit to operate the automation device, the computer code comprising:
program code for accessing a data warehouse of the automation solution by a technology-oriented control interpreter;
program code for analyzing, by the technology-oriented control interpreter, external commands and implementing said external commands according to said analysis to control the external commands;
program code for extracting, by the technology-oriented control interpreter, at least one entity designation and at least one instruction from a respective external command;
program code for searching, by the technology-oriented control interpreter, for an object matching the at least one entity designation in the data warehouse of the automation solution;
program code for checking whether the instruction contained in the command has been defined for the located object in an event of successfully locating the object matching the at least one entity designation in the data warehouse of the automation solution; and
program code for executing, via the technology-oriented control interpreter, the instruction for the located object.

12. A non-transitory computer program product having program code means which are stored on a non-transitory computer-readable data storage medium and executed on an automation device for at least one of controlling and/or monitoring an installation, the computer program comprising:
program code for accessing a data warehouse of the automation solution by a technology-oriented control interpreter;
program code for analyzing, by the technology-oriented control interpreter, external commands and implementing said external commands according to said analysis to control the external commands;
program code for extracting, by the technology-oriented control interpreter, at least one entity designation and at least one instruction from a respective external command;
program code for searching, by the technology-oriented control interpreter, for an object matching the at least one entity designation in the data warehouse of the automation solution;
program code for checking whether the instruction contained in the command has been defined for the located object in an event of successfully locating the object matching the at least one entity designation in the data warehouse of the automation solution; and
program code for executing, via the technology-oriented control interpreter, the instruction for the located object.

13. An automation device comprising:
a processing unit; and
a memory into which a computer program as claimed in claim 10 has been loaded, the computer program being executed by the processing unit during operation of the automation device.

14. An automation device comprising:
a processing unit; and
a memory into which a computer program as claimed in claim 10 has been loaded, the computer program being executed by the processing unit during operation of the automation device.
